(19) United States
(12) Patent Application Publication
(10) Pub. No.: US 2019/0032877 A1
(43) Pub. Date: Jan. 31, 2019

(54) SIMULATED CANDLE LAMP

(71) Applicants: Shanchang CHEN, Chenxi (CN); Chao Li, Wuhan City (CN); Qin ZHANG, Yuan an (CN); Wei HU, Wuhan City (CN)

(72) Inventors: Shanchang CHEN, Chenxi (CN); Chao Li, Wuhan City (CN); Qin ZHANG, Yuan an (CN); Wei HU, Wuhan City (CN)

(21) Appl. No.: 15/867,640

(22) Filed: Jan. 10, 2018

(30) Foreign Application Priority Data
Jul. 25, 2017 (CN) 201710613296.8

(51) Int. Cl. F21S 10/04; F21S 6/00; H02K 33/16

(52) U.S. Cl. CPC F21S 10/046; F21Y 2115/10; H02K 33/16; F21S 6/001

(57) ABSTRACT

The present invention provides a simulated candle lamp, including a housing, an LED light source, a candlewick sheet, and a vibration apparatus, where a candlewick through hole is disposed on the top of the housing; the candlewick sheet is an elastic soft sheet; the candlewick sheet has a flame-like upper portion; a lower portion of the candlewick sheet passes through the candlewick through hole and is connected and fixed to the vibration apparatus; the vibration apparatus drives the upper portion of the candlewick sheet to vibrate back and forth; and light of the LED light source is projected to the front of the upper portion of the candlewick sheet. When the lower portion of the candlewick sheet vibrates back and forth, the upper portion of the candlewick sheet has a larger amplitude due to the elasticity of the upper portion. In the projection of LED light, a soft halo effect appears on the edge. In addition, a highlight area to which the LED light is projected is always in the center of the flame and is matched with the halo on the edge. The effect is consistent with a flickering effect of a burning candle flame in a windless state, and the simulation degree is extremely high. A drive amplitude of the lower portion of the candlewick sheet may be very small. Therefore, the space of the simulated candle may be made very small, applicable to simulation of a small-size candle. The vibration drive manner with a small amplitude has low energy consumption.

### BACKGROUND

### Technical Field

The present invention relates to the technical field of simulated candle lamps, and in particular, to a candle lamp that can highly simulate a dynamic burning state of a candle flame.

### Related Art

With the development of technologies and the progress of society, open fire candles may be replaced with simulated candle lamps. On one hand, the simulated candle lamp can simulate a candle light effect; on the other hand, the simulated candle lamp is safe in use, and can effectively avoid a fire danger.

A candle lamp is generally divided into two parts of simulation design: a candlestick and a lampwick. The simulation design of the candlestick part is relatively simple and mature while the design of the lampwick part is still in a relatively low simulation degree state so far. At the beginning, in the structure of a simulated lampwick, a glowing bulb is built in a transparent lampwick-shaped housing, and the bulb is powered to glow to simulate a lampwick flame. Such a static lampwick has a very poor simulation effect, and can be used only in low-end occasions currently. Promoted by the market, a lampwick simulation structure that can simulate a dynamic flame appears later. However, currently, a lampwick with a relatively high simulation degree can simulate an effect of a flame vibrating with wind. For the structural principle, reference may be made to the Chinese patents No. ZL201520794365.6 and ZL201220059308.X. The structural principles of the foregoing technical solutions are similar, in which the middle of a candlewick sheet is designed to a structure that may freely move around a fulcrum, a magnet is then disposed at the bottom of the candlewick sheet, and an electromagnet is then disposed to generate a changing magnetic field to drive the magnet to generate a repulsion with a changing amplitude, to drive the candlewick sheet to vibrate to simulate an effect of a lampwick freely vibrating with wind. However, such a lampwick simulation structure still has relatively many disadvantages, which are specifically as follows: 1. The structure can only simulate an effect of a candle lampwick vibrating with wind, but cannot simulate an effect of a candle flame burning and flickering in a windless state. 2. The candlewick sheet simulates a flame freely vibrating with wind, and therefore, a vibration amplitude and direction of the candlewick sheet are random and uncontrollable. Therefore, a relatively large vibration space needs to be reversed at the lower side of the candlewick sheet, and the diameter of the candlestick needs to be made large. Such a structure cannot be used to simulate a small-diameter candle. 3. The candle lamp is generally powered by a battery with relatively low voltage. Therefore, the frequency of the electromagnet driving the candlewick sheet to vibrate is relatively low, a clear edge contour may be seen from the flame part of the candlewick sheet, there is no halo effect at the periphery of the candle flame, and the simulation effect is poor. 4. A flame highlight area of the candlewick sheet is simulated by radiating reflected light at the center of the candlewick sheet by using an LED lamp, but a radiation position is unchanged. However, the candlewick sheet randomly vibrates with a relatively large amplitude, causing the flame highlight area to ceaselessly deviate from the center of the candlewick sheet, and the simulation effect is poor. 5. The electromagnet needs to be powered continuously in a changing manner to generate repulsive force to drive the candlewick sheet to vibrate, and therefore, the power consumption is large, and a continuous use time is relatively short when the battery supplies power.

### SUMMARY

The objective of the present invention is to provide a candle lamp that can highly simulate a dynamic burning state of a candle flame.

To achieve the foregoing objective, the following technical solutions are used in the present invention.

A simulated candle lamp includes a housing, an LED light source, a candlewick sheet, and a vibration apparatus, where a candlewick through hole is disposed on the top of the housing; the candlewick sheet is an elastic soft sheet; the candlewick sheet has a flame-like upper portion; a lower portion of the candlewick sheet passes through the candlewick through hole and is connected and fixed to the vibration apparatus; the vibration apparatus drives the upper portion of the candlewick sheet to vibrate back and forth; and light of the LED light source is projected to the front of the upper portion of the candlewick sheet.

Compared with a conventional simulated candle, this solution has the following beneficial effects: 1. The vibration apparatus drives the candlewick sheet to vibrate. When the lower portion of the candlewick sheet vibrates back and forth at a frequency, the flame-like upper portion has a larger amplitude than the lower portion due to the elasticity of the upper portion. In the projection of LED light, a soft halo effect appears on the edge of the vibrating soft candle flame, and a vibration line at the top of the candle flame with the largest vibration amplitude is in a curved shape. Therefore, the halo effect is more obvious. In addition, the candlewick sheet vibrates back and forth. Therefore, a highlight area to which the LED light is projected is always in the center of the flame and is matched with the halo on the edge. The effect is consistent with a flickering effect of a burning candle flame in a windless state, and the simulation degree is extremely high. Even if the flame is observed close enough, it is difficult to identify the authenticity. 2.

The vibration apparatus is directly connected to the candlewick sheet to drive the candlewick sheet to vibrate, and compared with a vibration drive manner in the prior art, the vibration frequency and amplitude of the candlewick sheet are controllable. In addition, because the candlewick sheet is elastic, and the drive amplitude of the lower portion may be very small, the space of the simulated candle may be made very small, applicable to simulation of a small-size candle. 3. Compared with the manner in the prior art of driving, by using electromagnetic force, the candlewick sheet to vibrate, the vibration drive manner with a small amplitude has lower energy consumption, and the candle lamp has a longer use time and is more power-saving under equivalent conditions.

In a preferable manner, the vibration apparatus includes a magnet, a coil, and a PCBA that provides a drive current for the coil. The magnet is vertically fixed to the lower portion of the candlewick sheet and can move in an axial direction around an axis of the coil under the action of electromagnetic force of the coil. The principle of the vibration apparatus is as follows: The PCBA generates a changing current to drive the coil to generate a changing magnetic field. For example, an on/off current signal of a particular frequency is generated, so that the electromagnetic force generated by the coil drives the magnet to move in an axial direction at the particular frequency, to make the lower portion of the candlewick sheet vibrate horizontally. Because the magnet that drives the candlewick sheet to move moves in a stable direction, and its motion frequency is controllable and adjustable, the vibration apparatus can achieve an ideal vibration effect and has a simple structure and low costs.

In a preferable manner, the vibration apparatus includes an electromagnetic coil, a permanent magnet whose concentricity is disposed on the periphery of the electromagnetic coil, a drive circuit board for providing an oscillator signal to the electromagnetic coil, and a vibration membrane disposed on the electromagnetic coil and above the permanent magnet, where the vibration membrane is connected and fixed to the candlewick sheet; and the vibration membrane vibrates under the combined action of a magnetic field generated by the electromagnetic coil and the permanent magnet. Further, an inverted T-shaped iron core, a ring support, a clump weight, and a housing cap are further included. The electromagnetic coil, the permanent magnet, and the ring support are sleeved on the iron core concentrically from the inside out; the top of the ring support has a ring-shaped bearing platform, the vibration membrane is disposed on the ring-shaped bearing platform and has a spacing with the top surface of the iron core; the housing cap is covered on the periphery of the ring support and has a through hole at the top surface; and the clump weight passes through the through hole and connects and fixes the vibration membrane and the candlewick sheet. The structural principle of the vibration apparatus is similar to that of an electromagnetic buzzer, but the vibration apparatus cancels its sound production function, and only its vibration function remains. Therefore, the structure design is simpler, but many advantages of the electromagnetic buzzer remain: The size is small, the structure is simple and mature, the costs are low, and the power consumption is extremely low. Because the oscillator signal for driving the vibration membrane is provided by square waves that have a duty cycle, a higher vibration frequency indicates that more power can be saved.

In a preferable manner, the vibration apparatus includes a piezoelectric ceramic sheet with a silver electrode, and a multivibrator for driving the piezoelectric ceramic sheet to vibrate. The structural principle of the vibration apparatus is similar to that of a piezoelectric buzzer, but the vibration apparatus also cancels its sound production function, and only its vibration function remains. The structure is simpler, the size is small, the structure is simple and mature, the power consumption is very low, and the costs are low.

In a preferable manner, the vibration apparatus is a micro vibration motor. The micro vibration motor technology is mature, and when the micro vibration motor is used as the vibration apparatus of the present invention, an expected effect can be achieved. However, the costs and energy consumption are slightly higher than those in the previous two manners.

Further, the candlewick sheet is further relatively fixed to the housing at the lower side of the fixed position of the vibration apparatus. The bottom of the candlewick sheet is fixed to form a fulcrum. Driven by the vibration apparatus, the candlewick sheet has a larger vibration amplitude at the upper portion. Therefore, to achieve an expected simulation effect, a requirement on elasticity of the material of the candlewick sheet may be reduced, or the vibration apparatus may drive the candlewick sheet with a smaller amplitude. In this way, the energy consumption and costs are lower. The candlewick sheet is a silicone sheet or a rubber sheet. In addition to having elasticity and softness, the silicone sheet or the rubber sheet further has a semi-transparent property, and may be made into a diffuse reflection surface, so that the flame shape of the candlewick sheet is softer and more real. A power supply apparatus is disposed in the housing, and the power supply apparatus supplies power to the LED light source and the vibration apparatus.

### BRIEF DESCRIPTION OF THE DRAWINGS

The following further describes in detail the present invention with reference to the accompanying drawings and specific embodiments.

FIG. 1 is a schematic sectional structural view of a preferable embodiment of a candle lamp of the present invention;

FIG. 2 is a schematic exploded structural view of the candle lamp of the embodiment in FIG. 1;

FIG. 3 is a schematic sectional structural view of a part of the candle lamp of the embodiment in FIG. 1;

FIG. 4 is a schematic view of an appearance shape of an embodiment of a candle lamp of the present invention;

FIG. 5 is a schematic sectional structural view of a first embodiment of a vibration apparatus of the present invention;

FIG. 6 is a schematic exploded structural view of a vibration apparatus of the embodiment in FIG. 5;

FIG. 7 is a schematic sectional structural view of a second embodiment of a vibration apparatus of the present invention;

FIG. 8 is a schematic exploded structural view of the vibration apparatus of the embodiment in FIG. 7; and

FIG. 9 is a schematic sectional structural view of a third embodiment of a vibration apparatus of the present invention.

### DETAILED DESCRIPTION

The following further describes the present invention with reference to the accompanying drawings:

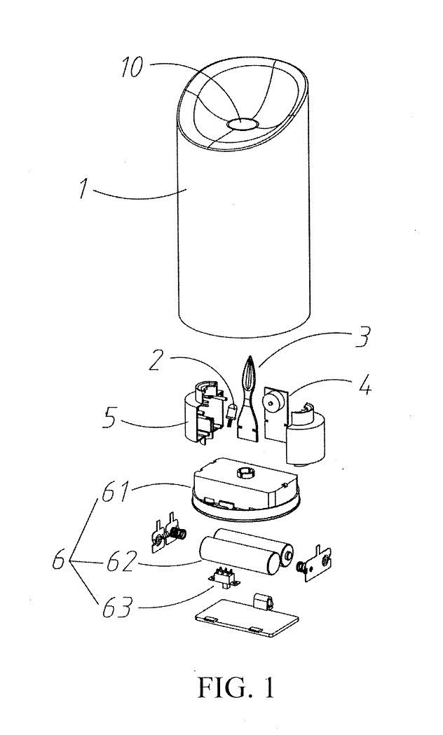

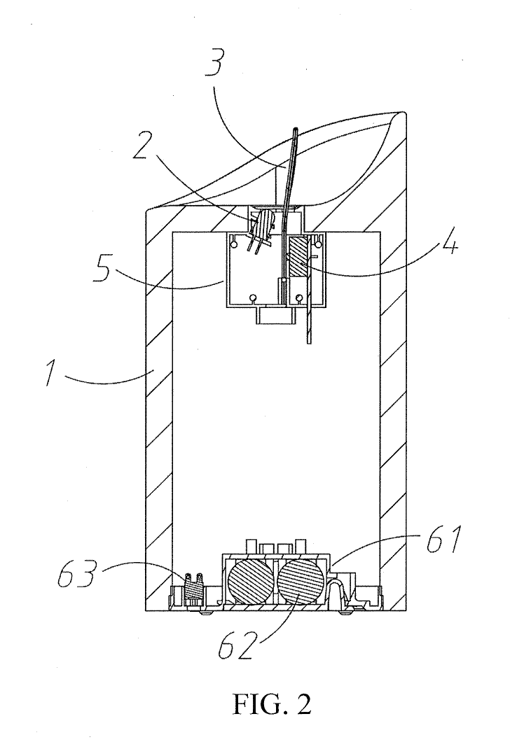

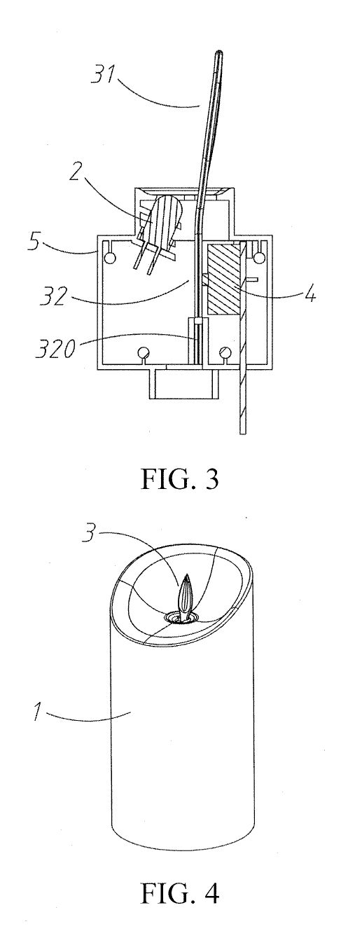

Referring to FIG. 1 to FIG. 4, a simulated candle lamp includes a housing 1, an LED light source 2, a candlewick sheet 3, a vibration apparatus 4, an installation support 5, and a power supply apparatus 6. The housing 1 may be designed into various different shapes or sizes. An accommodating cavity is disposed inside the housing 1, and is used to accommodate various structures for driving the candlewick sheet 3. A candlewick through hole 10 is disposed on the top of the housing 1. A vibration space for the candlewick sheet 3 to vibrate and a projection hole through which the LED light source 2 is projected onto the surface of the candlewick sheet 3 need to be reserved in the candlewick through hole 10. The candlewick sheet 3 is an elastic soft sheet, such as various silica gel materials, or soft plastic materials such as TPU, TPV, and TPE, and is preferably a silicone sheet or a rubber sheet. In addition to having elasticity and softness, the silicone sheet or the rubber sheet further has a semi-transparent property, and may be made into a diffuse reflection surface, so that the flame shape of the candlewick sheet is softer and more real.

The candlewick sheet 3 has a flame-like upper portion 31. A lower portion 32 of the candlewick sheet 3 passes through the candlewick through hole 10 and is connected and fixed to the vibration apparatus 4. The vibration apparatus 4 is fixed in the housing 1 through the installation support 5. The vibration apparatus 4 drives the upper portion 31 of the candlewick sheet 3 to vibrate back and forth. In a preferable implementation, the candlewick sheet 3 is further fixed to the installation support 5 at the lower side of the fixed position of the vibration apparatus 4. The bottom 320 of the candlewick sheet 3 is fixed to form a fulcrum. Driven by the vibration apparatus 4, the candlewick sheet 3 has a larger vibration amplitude at the upper portion 31. Therefore, to achieve an expected simulation effect, a requirement on elasticity of the material of the candlewick sheet 3 may be reduced, or the vibration apparatus 4 may drive the candlewick sheet 3 with a smaller amplitude. In this way, the energy consumption and costs are lower. Light of the LED light source 2 is projected to the front of the upper portion 31 of the candlewick sheet 3. For a preferable installation position, the LED light source 2 is to be obliquely fixed on the installation support 5, and its light passes through the candlewick through hole 10 and is projected to the front of the candlewick sheet 3. Certainly, the LED light source 2 may also be disposed on the candlewick sheet 3, and vibrate together with the candlewick sheet 3, but it is difficult to control the fixed position and angle. The power supply apparatus 6 supplies power to the LED light source 2 and the vibration apparatus 4. The power supply apparatus 6 includes a battery case 61 and a battery pack 62 disposed at the bottom of the housing 1, and a power switch 63 located outside the housing 1. The vibration apparatus 4 drives the candlewick sheet 3 to vibrate, and when the lower portion 32 of the candlewick sheet 3 vibrates back and forth at a frequency, the flame-like upper portion 31 has a larger amplitude than the lower portion 32 due to the elasticity of the upper portion 31. In the light projection of the LED light source 2, a soft halo effect appears on the edge of the vibrating soft candle flame, and a vibration line at the top of the candle flame with the largest vibration amplitude is in a curved shape. Therefore, the halo effect is more obvious. In addition, the candlewick sheet 3 vibrates back and forth. Therefore, a highlight area to which the light of the LED light source 2 is projected is always at the center of the flame and is matched with the halo at the edge. The effect is consistent with a flickering effect of a burning candle flame in a windless state, and the simulation degree is extremely high. Even if the flame is observed close enough, it is difficult to identify the authenticity. The vibration apparatus 4 is directly connected to the candlewick sheet 3 to drive the candlewick sheet 3 to vibrate, and the vibration frequency and amplitude of the candlewick sheet 3 are controllable. In addition, because the candlewick sheet 3 is elastic, and the drive amplitude of the lower portion 32 may be very small, the space of the simulated candle may be made very small, applicable to simulation of a small-size candle. Compared with the manner of driving, by using electromagnetic force, the candlewick sheet to vibrate, the vibration drive manner with a small amplitude has lower energy consumption, and the candle lamp has a longer use time and is more power-saving under equivalent conditions.

The effect of the vibration apparatus 4 is to drive the lower portion 32 of the candlewick sheet 3 to vibrate back and forth at a frequency and amplitude, to drive the upper portion 31 of the candlewick sheet 3 to vibrate in a larger amplitude, to achieve a simulation effect. Therefore, any vibration apparatus 4 can achieve the simulation effect of this solution as long as the vibration apparatus 4 has a vibration function and has a size small enough to be installed in the housing 1. The following is an exemplary preferable embodiment.

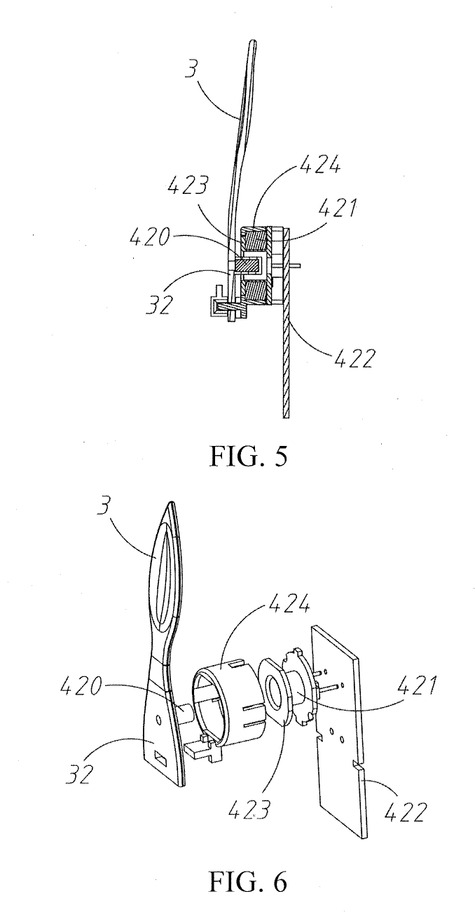

Referring to FIG. 5 and FIG. 6, a first embodiment of the vibration apparatus is as follows: The vibration apparatus includes a magnet 420, a coil 421, and a PCBA 422 that provides a drive current for the coil 421. The magnet 420 is vertically fixed to the lower portion 32 of the candlewick sheet 3 and can move in an axial direction around an axis of the coil 421 under the action of electromagnetic force of the coil 421. More specifically, the vibration apparatus further includes: a coil support 423 for fixing the coil 421, and a circular cover 424 that is disposed in such a manner as covering the outer part of the coil 421. The principle of the vibration apparatus is as follows: The PCBA 422 generates a changing current to drive the coil 421 to generate a changing magnetic field. For example, an on/off current signal of a particular frequency is generated, so that the electromagnetic force generated by the coil 421 drives the magnet 420 to move in an axial direction at the particular frequency, to make the lower portion 32 of the candlewick sheet 3 vibrate horizontally. Because the magnet 420 that drives the candlewick sheet 3 to move moves in a stable direction, and its motion frequency is controllable and adjustable, the vibration apparatus can achieve an ideal vibration effect and has a simple structure and low costs.

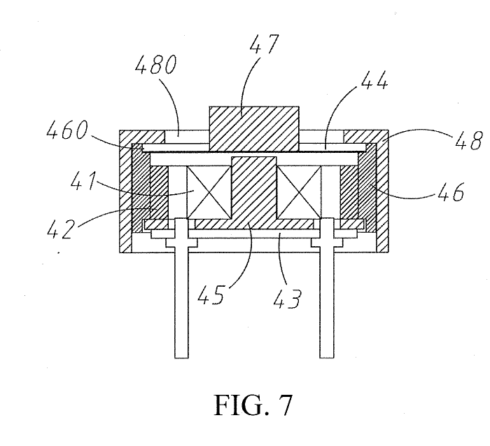

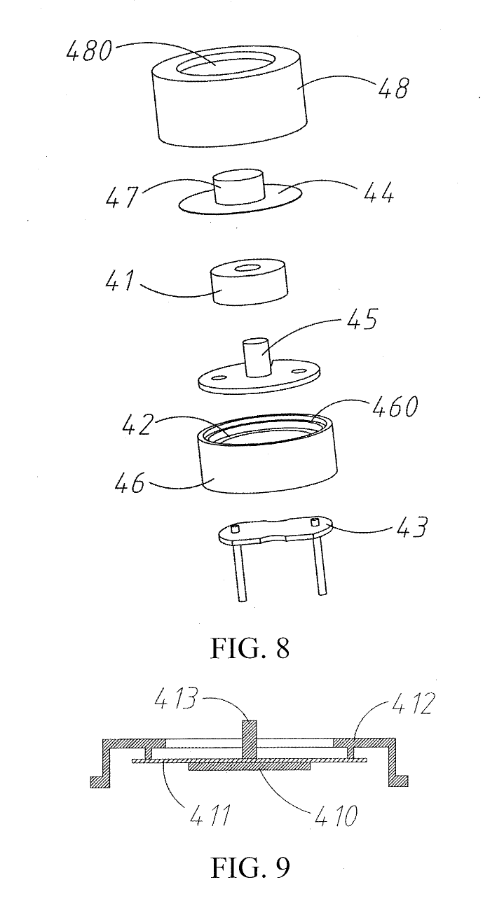

Referring to FIG. 7 and FIG. 8, a second embodiment of the vibration apparatus includes an electromagnetic coil 41, a permanent magnet 42 whose concentricity is disposed on the periphery of the electromagnetic coil 41, a drive circuit board 43 for providing an oscillator signal to the electromagnetic coil 41, and a vibration membrane 44 disposed on the electromagnetic coil 41 and above the permanent magnet 42. The vibration membrane 44 is connected and fixed to the candlewick sheet 3. The vibration membrane 44 vibrates under the combined action of a magnetic field generated by the electromagnetic coil 41 and the permanent magnet 42. The structural principle of the vibration apparatus 4 is similar to that of an electromagnetic buzzer, but the vibration apparatus 4 cancels its sound production function, and only its vibration function remains. Specifically, an inverted T-shaped iron core 45, a ring support 46, a clump weight 47, and a housing cap 48 are further included. The electromagnetic coil 41, the permanent magnet 42, and the ring support 46 are sleeved on the iron core concentrically from the inside out. The permanent magnet 42 and the ring support 46 may be integrated or may be separated. The top of the ring support 46 has a ring-shaped bearing platform 460. The vibration membrane 44 is disposed on the ring-shaped bearing platform 460 and has a spacing with the top surface of the iron core 45. The housing cap 48 is covered on the periphery of the ring support 46 and has a through hole 480 at the top surface. The clump weight 47 passes through the through hole 480 and connects and fixes the vibration membrane 44 and the candlewick sheet 3. Compared with the structure of the electromagnetic buzzer, the vibration apparatus 4 has a larger through hole 480 at the top of the housing cap 48 or even there is no housing cap 48. Therefore, key sound production structures of the electromagnetic buzzer: a resonant front cavity and a sound production hole, are lost. Therefore, the vibration apparatus 4 has no sound production function. Therefore, the structure of the vibration apparatus 4 is designed simpler than that of the electromagnetic buzzer, there is no need to strictly calculate parameters of parts for sound production, and many advantages of the electromagnetic buzzer remain: The size is small, the structure is simple and mature, the costs are low, and the power consumption is very low. Because the oscillator signal for driving the vibration membrane 44 is provided by square waves that have a duty cycle, a higher vibration frequency indicates that more power can be saved.

Referring to FIG. 9, a third embodiment of the vibration apparatus includes a piezoelectric ceramic sheet 410 with a silver electrode, and a multivibrator for driving the piezoelectric ceramic sheet 410 to vibrate. Certainly, the piezoelectric ceramic sheet 410 may further be adhered to brass or a stainless steel vibration sheet 411, to expand its vibration amplitude. Then, a connecting pole 413 may be disposed to connect and fix the center of the vibration sheet 411 and the lower portion 32 of the candlewick sheet 3.

However, that the vibration sheet 411 produces no sound needs to be used as the precondition of the design of the diameter of the vibration sheet 411 and the weight of the connecting pole 413. Generally, no resonant cavity structure is provided, but only a fixed support 412 is disposed, to prevent sound production. The structural principle of the vibration apparatus is similar to that of a piezoelectric buzzer, but the vibration apparatus also cancels its sound production function, and only its vibration function remains. The structure of the vibration apparatus is simpler than that of the piezoelectric buzzer, the costs are lower, the size is small, the structure is simple and mature, and the power consumption is very low.

In a third embodiment of the vibration apparatus, the vibration apparatus is a micro vibration motor. The micro vibration motor technology is mature, and when the micro vibration motor is used as the vibration apparatus of the present invention, an expected effect can be achieved. However, the costs and energy consumption are slightly higher than those in the previous two manners.

The foregoing description is not construed as any limitation on the technical scope of the present invention, and any modifications, equivalent variations, and decorations made to the foregoing embodiments without departing from the technical essence of the present invention shall fall within the scope of the technical solutions of the present invention.

What is claimed is:

1. A simulated candle lamp, comprising a housing, an LED light source, a candlewick sheet, and a vibration apparatus, wherein a candlewick through hole is disposed on the top of the housing; the candlewick, sheet is an elastic soft sheet; the candlewick sheet has a flame-like upper portion; a lower portion of the candlewick sheet passes through the candlewick through hole and is connected and fixed to the vibration apparatus; the vibration apparatus drives the upper portion of the candlewick sheet to vibrate back and forth; and light of the LED light source is projected to the front of the upper portion of the candlewick sheet.

2. The simulated candle lamp according to claim 1, wherein the vibration apparatus comprises a magnet, a coil, and a PCBA that provides a drive current for the coil; and the magnet is vertically fixed to the lower portion of the candlewick sheet and can move in an axial direction around an axis of the coil under the action of electromagnetic force of the coil.

3. The simulated candle lamp according to claim 1, wherein the vibration apparatus comprises an electromagnetic coil, a permanent magnet whose concentricity is disposed on the periphery of the electromagnetic coil, a drive circuit board for providing an oscillator signal to the electromagnetic coil, and a vibration membrane disposed on the electromagnetic coil and above the permanent magnet, wherein the vibration membrane is connected and fixed to the candlewick sheet; and the vibration membrane vibrates under the combined action of a magnetic field generated by the electromagnetic coil and the permanent magnet.

4. The simulated candle lamp according to claim 3, further comprising an inverted T-shaped iron core, a ring support, a clump weight, and a housing cap, wherein the electromagnetic coil, the permanent magnet, and the ring support are sleeved on the iron core concentrically from the inside out; the top of the ring support has a ring-shaped bearing platform;
the vibration membrane is disposed on the ring-shaped bearing platform and has a spacing with the top surface of the iron core; the housing cap is covered on the periphery of the ring support and has a through hole at the top surface; and the clump weight passes through the through hole and connects and fixes the vibration membrane and the candlewick sheet.

5. The simulated candle lamp according to claim 1, wherein the vibration apparatus comprises a piezoelectric ceramic sheet with a silver electrode, and a multivibrator for driving the piezoelectric ceramic sheet to vibrate.

6. The simulated candle lamp according to claim 1, wherein the vibration apparatus is a micro vibration motor.

7. The simulated candle lamp according to claim 1, wherein the candlewick sheet is further relatively fixed to the housing at the lower side of the fixed position of the vibration apparatus.

8. The simulated candle lamp according to claim 1, wherein the candlewick sheet is a silicone sheet or a rubber sheet.

9. The simulated candle lamp according to claim 1, wherein a power supply apparatus is disposed in the housing, and the power supply apparatus supplies power to the LED light source and the vibration apparatus.
